(19) United States
(12) Patent Application Publication
(10) Pub. No.: US 2011/0055330 A1
(43) Pub. Date: Mar. 3, 2011

(54) THIRD PARTY E-MAIL MARKETING INTEGRATION

(75) Inventors: Bill BUCK, Markham (CA); Colin LEE, Thornhill (CA); Tony BORGES, Brooklin (CA); Lawrence HA, Scarborough (CA); Calvin SETO, Thornhill (CA)

(73) Assignee: JONAS SOFTWARE, Richmond Hill (CA)

(21) Appl. No.: 12/548,183

(22) Filed: Aug. 26, 2009

(51) Int. Cl. G06F 15/16

(52) U.S. Cl. 709/206

(57) ABSTRACT

A method for e-mail marketing includes the steps of (a) storing member information in a member database on a server, the member information including a set of member data fields; (b) selecting a subset of the member data fields; (c) providing the subset of member data fields to a third-party e-mail marketing service provider, wherein third-party e-mail service marketing provider stores the subset of member data fields in a distribution database; and, (d) distributing e-mail marketing material to one or more members using services provided by the third-party e-mail marketing service provider.

### FIELD OF THE INVENTION

The present invention is directed to a system and method for third-party e-mail marketing integration, and more specifically to a system and method for integrating a third-party e-mail marketing system with a club membership system.

### BACKGROUND OF THE INVENTION

Many clubs, such as golf clubs, have a membership base and use a member database for maintaining membership information, such as biographical information, account information, and other membership information. Typically. this member database may be used to communicate en masse with groups of members, control access to the club and related services, and to generate reports on various aspects of a member's use of the club.

One such member database and software interface for such is the Jonas™ Club Management System produced by Jonas™ Software of Richmond Hill. Ontario Canada. This club management system is an all encompassing solution for organizing and running a membership-oriented business and includes a wide variety of accounting, membership and billing features. Generally, when the club needs to communicate with a number of members, the membership database is accessed to provide a list of desired members to receive a particular piece of communication. The membership database will also include contact information for each member, and thus, the communication may be sent. Such communications may be presented by a telephone call, regular mail, e-mail, or any other means based on the contact information included in the database.

The present application relates broadly to e-mail communications to be sent to a number of members. In the prior art club management systems, the membership database included functionality for generating lists of members to receive a particular piece of communication. When these communications are distributed, they are done so manually or via computer programs able to receive the lists of members to receive the communication. Such systems are generally ineffective and require significant human interaction.

There is thus a need in the art for a system and method of allowing the management of a club running a club management system to quickly and efficiently communicate with the membership via targeted e-mail campaigns.

### SUMMARY OF THE INVENTION

Accordingly, a method for e-mail marketing is disclosed which includes the steps of storing member information in a member database on a server, the member information comprising a set of member data fields; selecting a subset of the member data fields; providing the subset of member data fields to a third-party e-mail marketing service provider, wherein the third-party e-mail service marketing provider stores the subset of member data fields in a distribution database; and, distributing e-mail marketing material to one or more members by using services provided by the third-party e-mail marketing service provider. Optionally, the step of selecting a subset further includes selecting a plurality of subsets and said step of providing a subset further includes providing said plurality of subsets.

The subset of said member data fields may include fields containing static data. Static data includes, but is not limited to, one or more of a member's name, identification number, e-mail address, birth date, status, address, and other fixed data associated with a member.

The subset of member data fields may also include fields containing dynamic data. Dynamic data includes. but is not limited to, one or more of an accounts receivable balance, number of visits, minimum amount spent, and other dynamic data calculable or recordable over time.

According to one aspect of the present invention, the services provided by the third-party e-mail marketing provider optionally includes identifying a target list of members to receive the e-mail marketing material based on a filter applied to the distribution database. The aforementioned filter may comprise a selection of one or more members based on criteria applied to the subset of member data fields.

According to another aspect of the present invention, the dynamic data may he Updated periodically on the member database and periodically synchronized with the distribution database.

According to a further embodiment of the present invention, the step of providing the subset of member data fields to a third-party e-mail marketing provider optionally includes providing the subset of member data fields to the third-party e-mail marketing provider via an application programming interface supplied by the third-party e-mail marketing provider.

Preferably, the member database forms part of a club management system, and a management interface may be provided on the club management system for interacting with the application programming interface.

According to another aspect of the present invention, the management interface includes a filter to be applied to the subset of member data fields to identify a target list of members to receive the e-mail marketing material. In this case, the step of providing the subset of member data fields to the third-party e-mail marketing service provider includes providing the target list to the third-party e-mail marketing service provider.

According to another aspect of the present invention, a filter is applied to the subset of member data fields to identify a target list of members to receive the e-mail marketing material and the step of providing comprises providing the target list to the third-party e-mail marketing service provider. Optionally, one or more shortcut filters are provided and selectable via the management interface to identify the target list of members.

According to another aspect of the present invention, the member data fields are mapped onto correspondingly named data fields on the distribution database. Preferably, the fields containing dynamic data are updated during periodic report generation of dynamic member data. The report generation may be automated to run unattended at pre-defined times, for example, at pre-defined times of the day.

According to another embodiment of the present invention, there is provided a method for providing data to a third-party e-mail marketing service provider, wherein the third-party e-mail marketing service provider supplies an application programming interface for interacting with a user. The method includes storing member information in a member database on a server including a set of member data fields, selecting a subset of the data fields as being relevant to identifying one or more members to receive e-mail marketing material, providing the subset of data fields to the e-mail marketing service via the application programming interface.

### BRIEF DESCRIPTION OF THE DRAWINGS

An embodiment of this invention will now be described by way of example only in association with the accompanying drawings in which:

FIG. 1 is a flowchart showing the method according to the present invention.

FIG. 2 is a schematic illustration of the devices used in the method of FIG. 1.

FIG. 3 shows a representative database mapping interface according to one aspect of the present invention.

FIG. 4 shows a representative database field selector for use with the interface of FIG. 3.

FIG. 5 shows a representative general interface for interacting with an application programming interface according to a second aspect of the present invention.

FIG. 6 shows a representative filter interface forming part of the general interface of FIG. 5.

FIG. 7 shows additional details of the filter interface of FIG. 6.

FIG. 8 shows a representative mapping interface forming part of the general interface of FIG. 5.

FIG. 9 shows a representative interface for defining database fields.

FIG. 10 shows the mapping interface of FIG. 8 as would appear in use.

FIG. 11 shows a representative scheduler interface forming part of the general interface of FIG. 5.

FIG. 12 shows a pre-programmed shortcut for uploading a filtered dataset according to a further aspect of the present invention.

FIG. 13 shows a variation of the pre-programmed shortcut for uploading a filtered dataset of FIG. 12.

FIG. 14 shows another embodiment of a filter interface according to one aspect of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in presently preferred embodiments of the invention will now be illustrated by way of example only. In the drawings, like reference numerals depict like elements. It is expressly understood. however, that the drawings are for the purpose of illustration and description only and are not intended as a definition of the limits of the invention.

While the disclosure refers to club management systems, and in particular, golf club management systems, it will be understood that these are referenced for ease of understanding the invention only, and are not to be considered limiting.

The present invention relates generally to a method for e-mail marketing. For the purposes of this disclosure, the term marketing is used in a broad sense to refer to the distributing of any piece of communication which aids in enhancing, defining, or otherwise improving the business relationship between the sender of the e-mail and the recipient. Such communications may include, but are not limited to, product advertisements, event advertisements, club announcements relating to its membership, general informative messages, surveys, promotional announcements, and others which would be apparent to those skilled in the art.

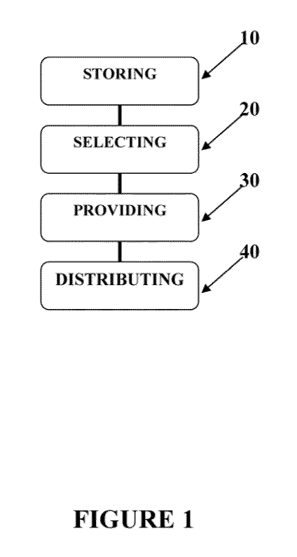

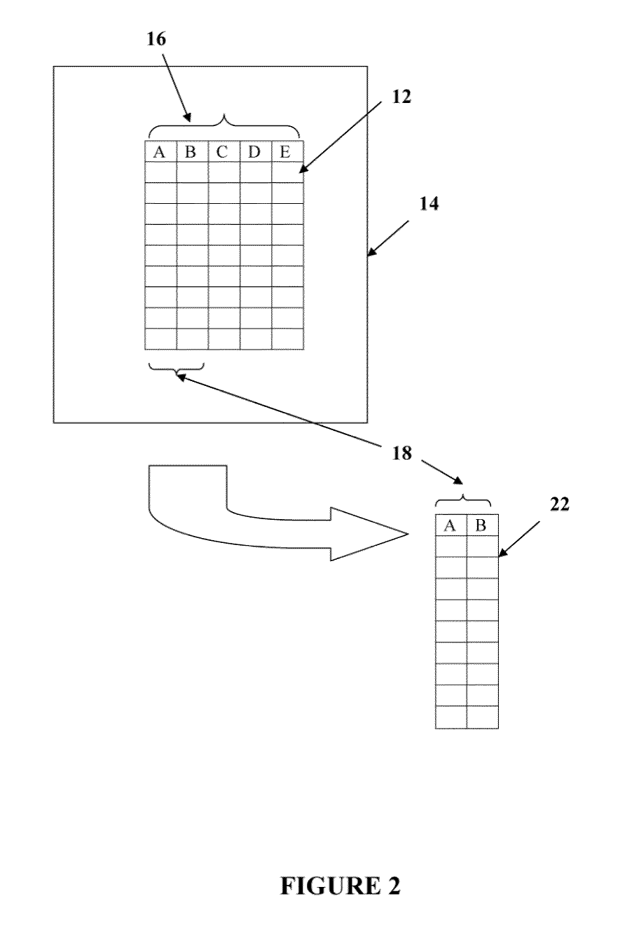

With reference to FIGS. 1 and 2, in a first step 10 of the method according to the present invention, member information is stored by a club in a member database 12 on a server 14. The member information includes a set of member data fields 16. The set of data fields 16 preferably includes the name of each member of the club, and one or more additional fields containing additional information, as described below. Preferably, the set of member data fields includes both static data fields and dynamic data fields.

Static data fields are those which include generally unchanging. or rarely changing, data regarding a particular member. These may include, but are not limited to, a member's name, birth date, address, marital status, club membership status, membership number, telephone number, e-mail address, contact preferences, locker number, parking spot number, and any other data fields as would be known to one skilled in the art.

Dynamic data fields are those which are updated on a regular, or semi-regular, basis and include data on a particular member related to information which updates. accumulates. is calculable or is dependent on the member's actions at the club over specific time periods. These may include, but are not limited to, an accounts receivable balance, spending at the club over a given time period, number of visits, minimum amount spent, and other data as would be apparent to one skilled in the art.

According to a second step 20 of the present invention, a subset 18 of the member data fields 16 as provided in step 10 is selected to be provided to a third-party e-mail marketing service provider. The third-party e-mail marketing service provider stores the subset of the member data fields in a distribution database 22. The subset of data fields provided to the third-party e-mail marketing service provider may include one or more of the static and dynamic data fields. Such subset .is selected to optimize the amount of information submitted to the third-party e-mail marketing service provider, and stored on the distribution database, by providing only the data fields which are required to identify particular members who are to receive intended communications. For example, if the third-party e-mail marketing service provider is engaged to send out e-mails to a member on their birthday. the subset may only include the member's name field, birth date field, and e-mail address field. Thus, interaction with the entire member database is not required to send out such birthday e-mails.

Optionally, a filter may be applied to the subset of member data fields prior to providing such to the third-party e-mail marketing service provider to limit the amount of data stored on the distribution database.

In step 40, e-mail marketing material is distributed to one or more members using services provided by the third party-email marketing service provider. Services provided by the third-party e-mail marketing service provider would include functionality allowing the club to identify a target list of members to receive a particular e-mail marketing communication based on a filter applied to the distribution database. Such filters are applied to select one or more members based on a preselected set of criteria applied to the distribution base. According to the preceding example. the filter would be applied to identify only those members whose birth date corresponds to the present days date. and subsequently only those members will receive the e-mail communication.

Alternatively, a filter may be applied to the subset of member data fields to identify a target list of members to receive the e-mail marketing material. In this case, when providing the subset to the third-party e-mail marketing service provider, a filtered list containing only those pre-selected data fields will be sent.

Preferably, the third-party e-mail marketing service provider will provide an application programming interface (API) via which the club management system can interact with those services provided by the third-party e-mail marketing service provider. The API may be used to provide, for example, a list of field names as present on the member database and an appropriate mapping of such onto the distribution database of the third-party e-mail marketing service provider.

While the above describes the general concepts of a preferred embodiment of the present invention, a more detailed description of various aspects and methods and systems for implementing present invention will now follow.

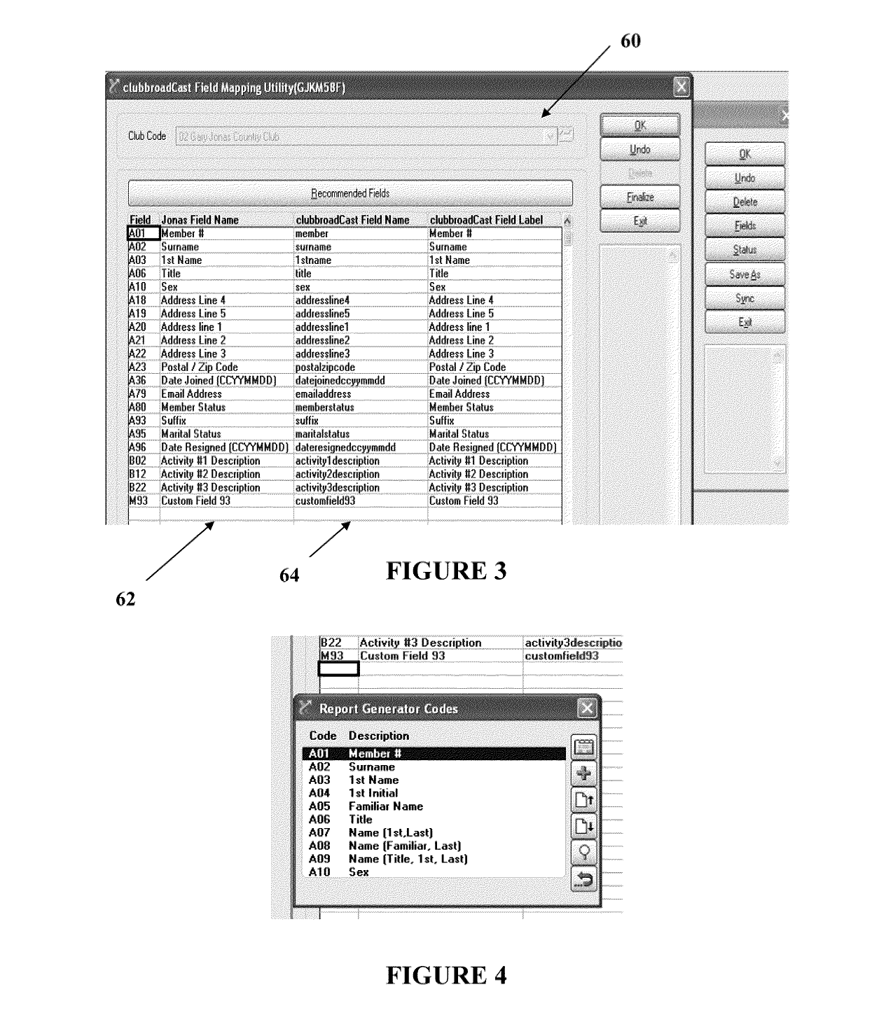

FIG. 3 shows a management interface 60 arranged to interact with the API in exchanging data between the member database and the distribution database. A number of exemplary fields on the member database 62 are arranged to map onto like-named fields on the distribution database 64 via the interface. Those fields arranged to be mapped represent the subset of fields selected from the member database to be provided to the third-party e-mail marketing service provider. A user, such as a manager at the club, may add additional fields to be mapped by first selecting the appropriate field on the member database (as shown in FIG. 4). and assigning a field name to the field on the distribution database. Preferably, by default, the field names will correspond on the member database and on the distribution database. Only those fields which are mapped are uploaded to the third-party e-mail marketing service provider. Thus, the user selects only those fields which are necessary for the distribution of a particular type of marketing material.

As will be apparent to those skilled in the art, a plurality of subsets, or lists, may be provided to the third-party e-mail marketing service provide. Thus. separate lists may be established depending on the type of communication to be sent out. One or more lists may contain only static data fields, while others may contain only dynamic data fields and preferably one or more lists will contain both static and dynamic data fields. The inclusion of a plurality of subsets is entirely optional and can be used, for example, to minimize processing time on the distribution database, or for ease of processing, by sending e-mail marketing material to entire lists only.

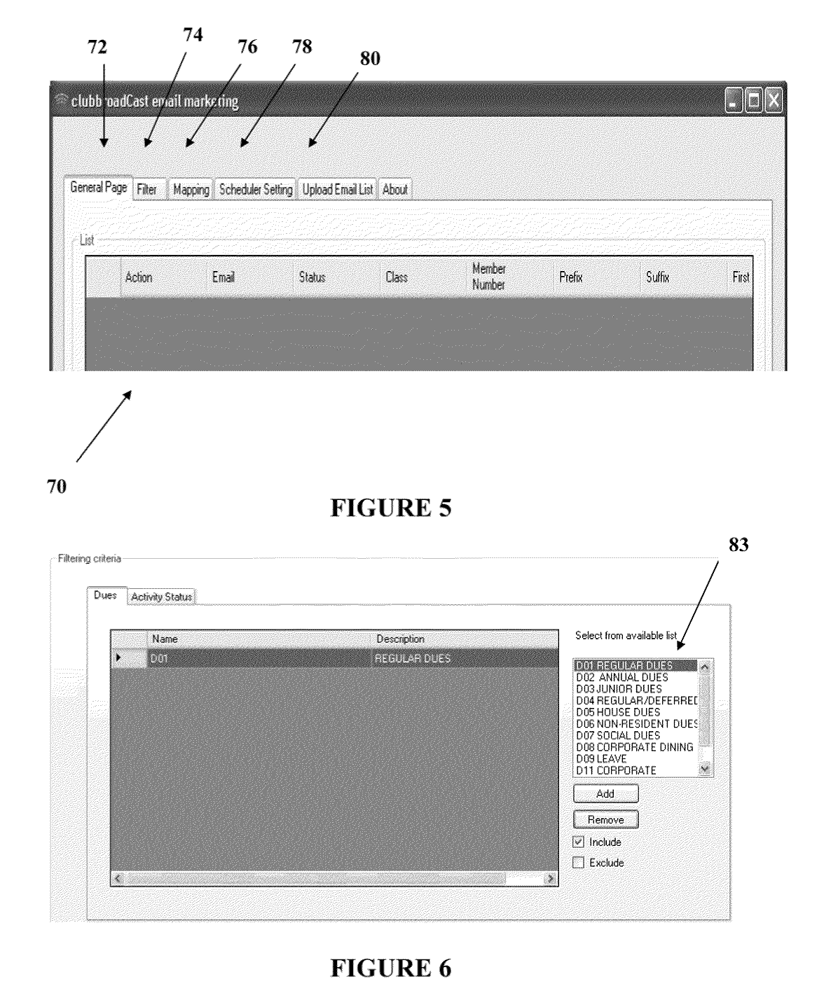

According to another embodiment of the present invention, an alternate management interface 70 is provided between the club management system and the third-party e-mail marketing service provider. The interface of FIG. 5 includes tabs showing a general list 72, a filter applied 74. a mapping to the distribution database 76, a scheduler setting 78 and an e-mail list to be uploaded 80. The general list initially includes all information in the member database.

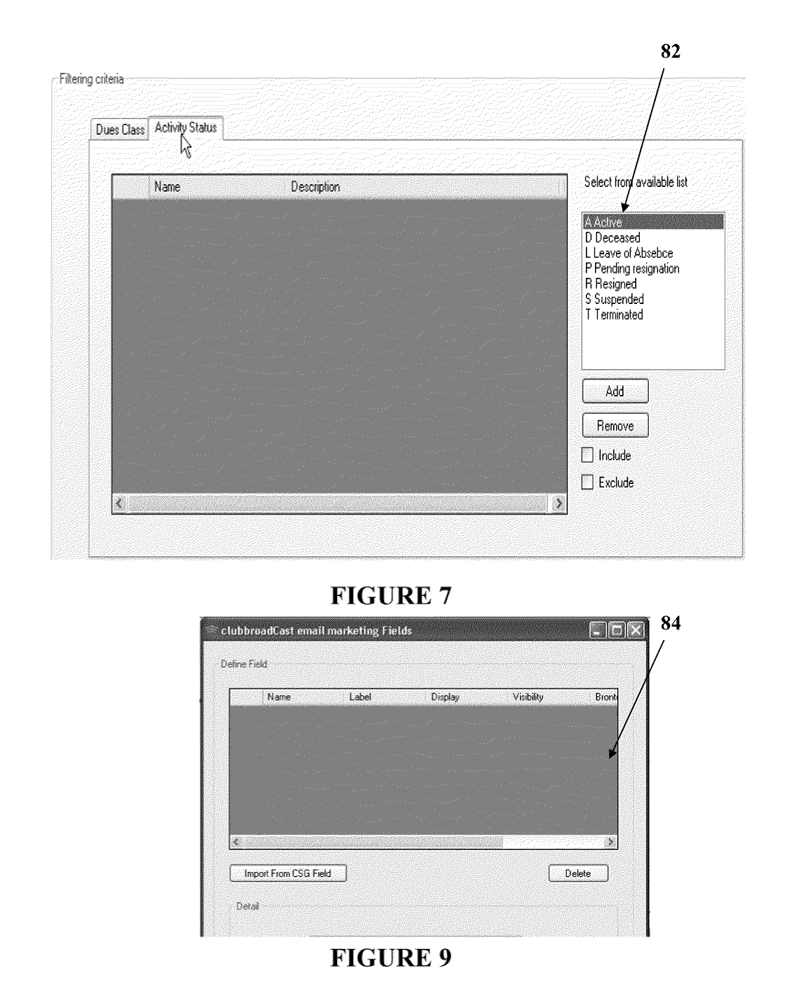

The filter tab 74 is used to apply a filter to the member database in selecting a subset of members who may receive a particular type of communication. In the example shown in FIGS. 6 and 7, the amount a member is paying in ‘Regular Dues’ 80 and the member's status 83 are selected. That is, only those members who have regular membership dues on their account and are presently active members are selected.

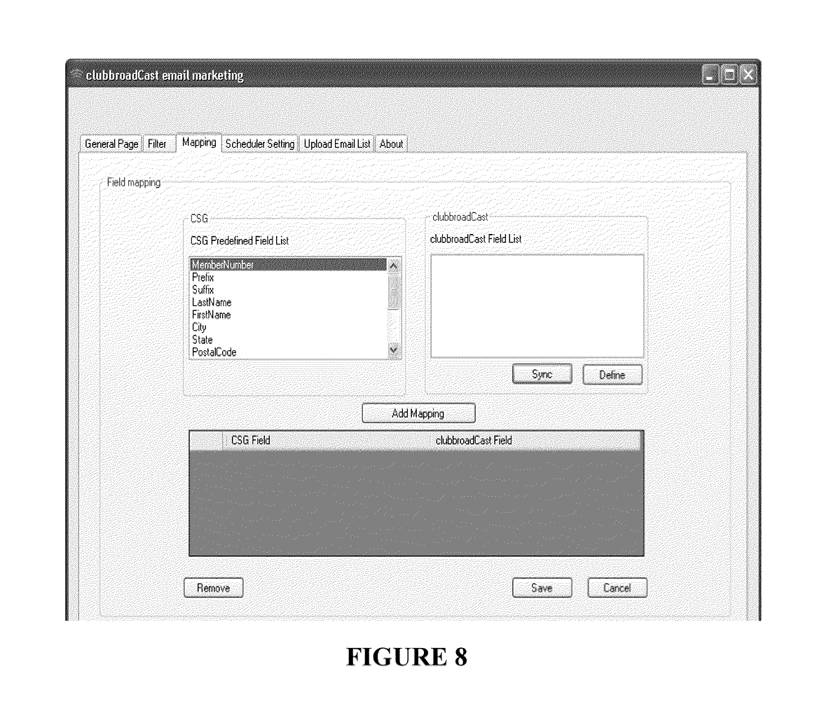

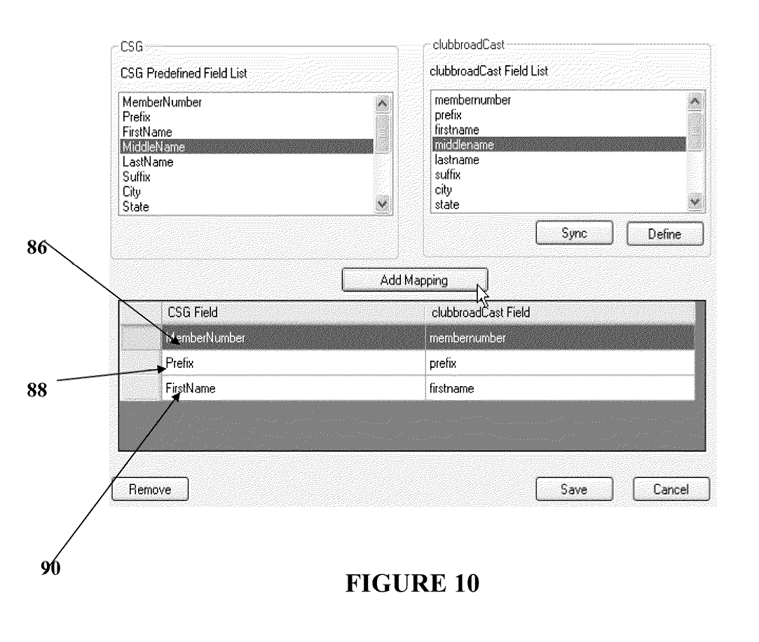

The mapping tab 76. as shown in FIG. 8, is then used to select fields to be mapped over from the membership database to the distribution database. A define field interface 84 may he provided to define particular fields on the distribution database, as shown in FIG. 9. Such a step is generally required upon generation of a new distribution list. An option may be provided to map all existing fields from the membership database onto the distribution database. Once the fields are defined, they can be mapped over. An example of such a mapping is shown in FIG. 10, wherein the member number 86, prefix 88, and first name 90 fields are shown to be mapped. As shown, a mapping for. the middle name is presently being added. Typically, the naming convention on both databases will be similar.

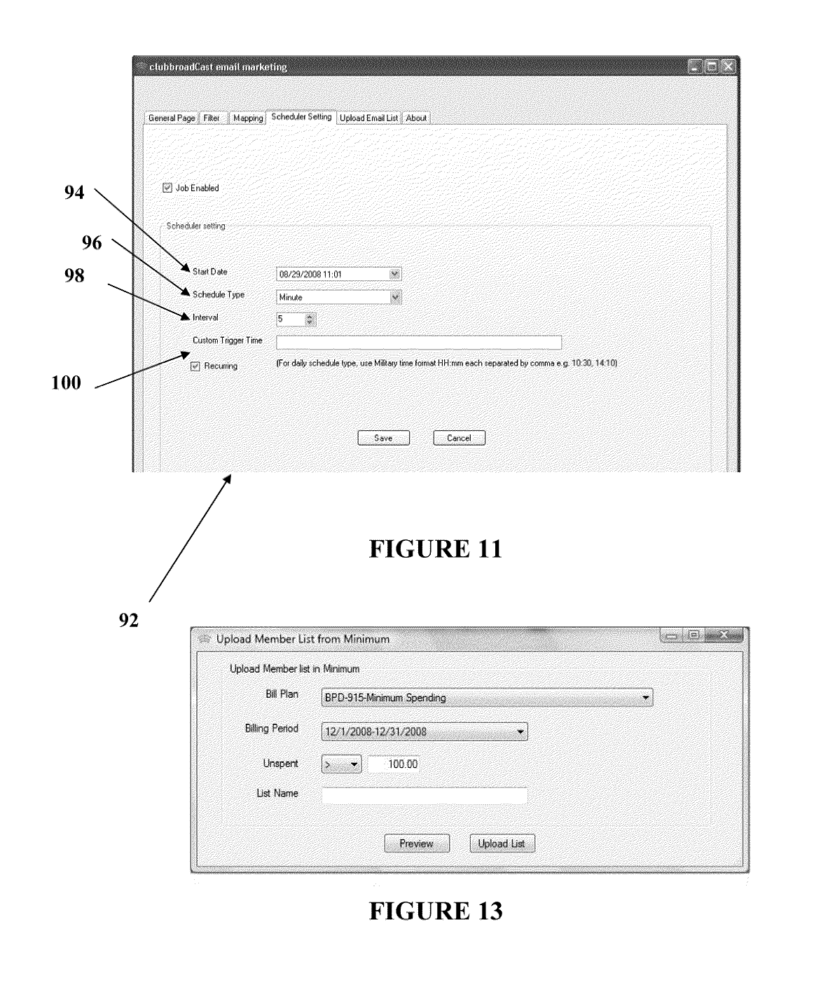

FIG. 11 shows an example of a scheduler 92 for defining pre-determined updates to the distribution database. The scheduler is used to automatically, at timed intervals, send the filtered members to the third-party e-mail marketing service provider's distribution database. The scheduler may include fields defining the start date 94, schedule type 96 and interval 98. A custom trigger time 100 may also be provided, for example. to update the distribution database at the same time each day.

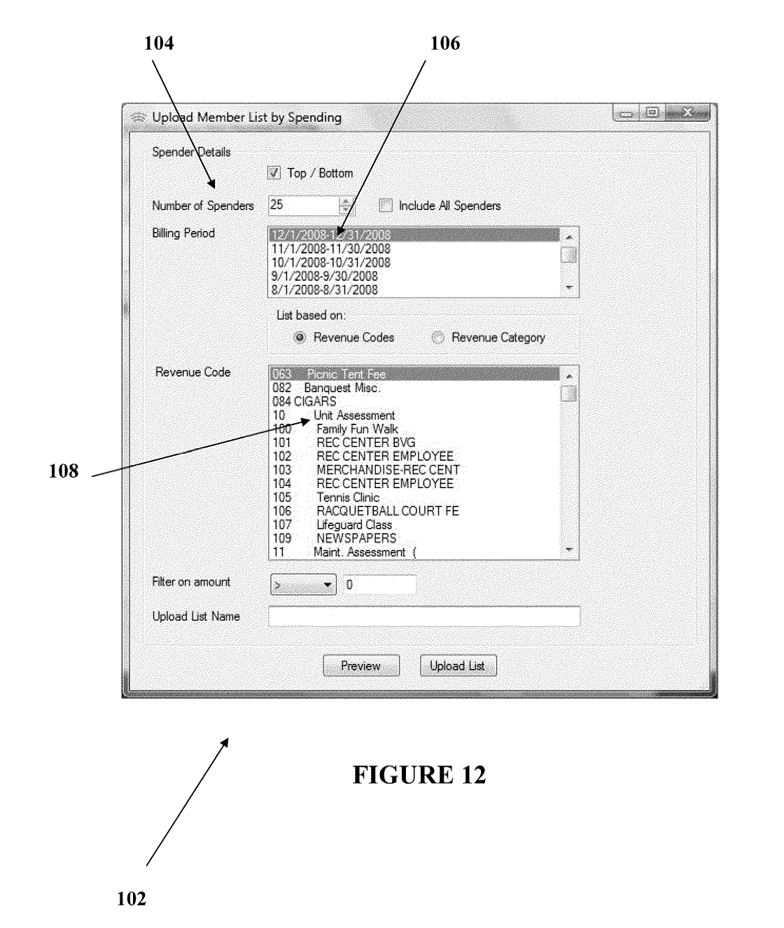

For recurring filters, shortcuts may be provided. For example, a list containing members who spend certain amounts is generally common in marketing campaigns. Such a shortcut 102 is shown in FIG. 12. This pre-programmed shortcut filter allows the club management to select a number of spenders on certain types of fees and upload this list to the distribution database. For example, in FIG. 12, the top 25 spenders 104 for the billing period 106 of December at the ‘Picnic Tent’ 108 are selected to be uploaded. FIG. 13 illustrates another pre-programmed shortcut filter, wherein only those members with a minimum spending of $100 during December, 2008 are selected to be uploaded. It will be understood by those skilled in the art that such recurring filter shortcuts may be provided for filters applied to either the membership database or the distribution database as herein described.

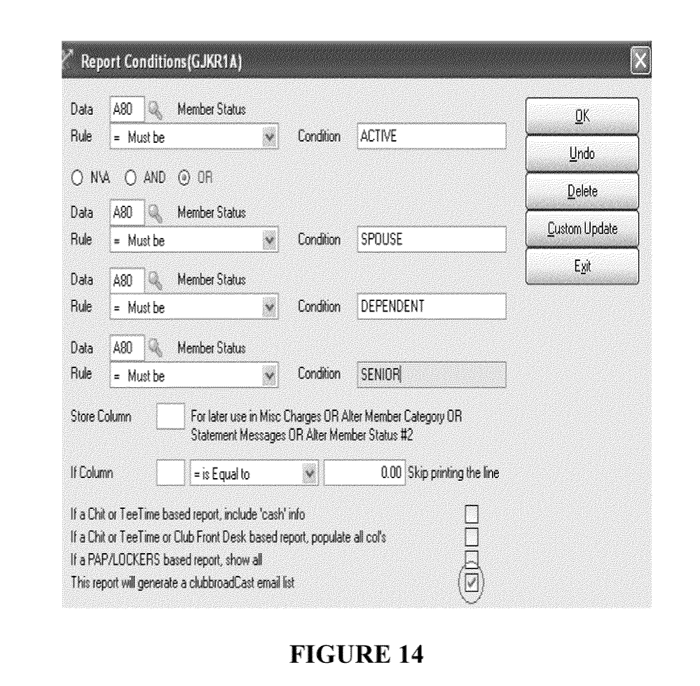

According to another embodiment of the present invention, the filter may be applied directly on the member database. FIG. 14 shows an example of a filter applied to the member database to generate a list of all active members, including their spouses, dependents and senior members. When generating a list of this sort, the entire list can be provided to the third-party e-mail marketing service provider. Alternatively, such a filter may be applied to the distribution database to ensure that only active members receive a particular type of marketing material.

The API provided by the third-party e-mail marketing service provider may provide such interfaces integrated directly within the club management system. Thus, interaction between the member database and the distribution database can be seamless and proceed relatively unnoticed by a user accessing the club management system.

A number of the above steps may be automated. That is, the club management may provide pre-programmed routines to be run which generate automated lists periodically, or provide periodic updates to the distribution database. Such updates may be run, for example, by providing a button which synchronizes the updates on the membership database with those fields mapped on to the distribution database and updates these accordingly.

In use, a club running the club management software will be supplied with the required interface components for interacting with the third-party e-mail marketing service provider. This may be. for example, by supplying a CD or a link to a downloadable interface. The interface and related components will then be installed to interact with the club management software. Optionally, the activation may be required by the supplier of the interface, for example, by telephone or e-mail communications. This activation may be in the form of a security key required to be entered prior to a first use of the interface.

While the above description identifies certain fields, database labels, or information stored, it will be understood by one skilled in the art that these are provided for example only and are not to be considered limiting of the invention.

Thus, it is apparent that there has been provided, in accordance with the present invention, a protective covering system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

1. A method for e-mail marketing comprising:
storing member information in a member database on a server, said member information comprising a set of member data fields;
selecting a subset of said member data fields;
providing said subset of said member data fields to a third-party e-mail marketing service provider, wherein said third-party e-mail service marketing provider stores said subset of said member data fields in a distribution database; and,
distributing e-mail marketing material to one or more members by using services provided by said third-party e-mail marketing service provider.

2. A method for e-mail marketing according to claim 1, wherein said subset of said member data fields includes fields containing static data including one or more of a member's name, identification number, e-mail address, birth date, status, address, and other fixed data associated with a member.

3. A method for e-mail marketing according to claim 2, wherein said subset of said member data fields further includes fields containing dynamic data including one or more of an accounts receivable balance, number of visits, minimum amount spent, and other dynamic data calculable or recordable over time.

4. A method for e-mail marketing according to claim 3, wherein said services provided by said third-party e-mail marketing provider includes:
identifying a target list of members to receive said e-mail marketing material based on a filter applied to said distribution database.

5. A method for e-mail marketing according to claim 4, wherein said filter comprises a selection of one or more members based on criteria applied to said subset of said member data fields.

6. A method for e-mail marketing according to claim 3, wherein said dynamic data is updated periodically on said member database and periodically synchronized with said distribution database.

7. A method for e-mail marketing according to claim 6, wherein said step of providing said subset of said member data fields to a third-party e-mail marketing provider includes providing said subset of said member data fields to said third-party e-mail marketing provider via an application programming interface supplied by said third-party e-mail marketing provider.

8. A method for e-mail marketing according to claim 7, wherein said member database forms part of a club management system, and wherein a management interface is provided on said club management system for interacting with said application programming interface.

9. A method for e-mail marketing according to claim 8, wherein said management interface provides a filter to be applied to said subset of said member data fields to identify a target list of members to receive said e-mail marketing material and wherein said step of providing comprises providing said target list to said third-party e-mail marketing service provider.

10. A method for e-mail marketing according to claim 9, wherein one or more shortcut filters are provided and selectable via said management interface to identify said target list of members.

11. A method for e-mail marketing according to claim 1, wherein said step of selecting a subset further includes selecting a plurality of subsets and said step of providing a subset further includes providing said plurality of subsets.

12. A method for e-mail marketing according to claim 3, wherein a filter is applied to said subset of said member data fields to identify a target list of members to receive said e-mail marketing material and wherein said step of providing comprises providing said target list to said third-party e-mail marketing service provider.

13. A method for e-mail marketing according to claim 2, wherein said member data fields are mapped onto corresponding data fields on said distribution database.

14. A method for e-mail marketing according to claim 13 wherein said fields containing dynamic data are updated during periodic report generation of dynamic member data.

15. A method for e-mail marketing according to claim 14 wherein said report generation is automated to run unattended at pre-defined times.

16. A method for providing data to a third-party e-mail marketing service provider, wherein said third-party e-mail marketing service provider supplies an application programming interface for interacting with a user, said method comprising:
storing member information in a member database on a server including a set of member data fields,
selecting a subset of said data fields as being relevant to identifying one or more members to receive e-mail marketing material,
providing said subset of said data fields to said e-mail marketing service via said application programming interface.

17. A method for providing data to a third-party e-mail marketing service provider according to claim 16, wherein said subset of said member data fields includes static data including one or more of a member's name, identification number, e-mail address, birth date, status, address, and other fixed data associated with a member.

18. A method for providing data to a third-party e-mail marketing service provider according to claim 17, wherein said subset of said member data fields further includes dynamic data including one or more of an accounts receivable balance, number of visits, minimum amount spent, and other dynamic data calculable or recordable over time.

19. A method for providing data to a third-party e-mail marketing service provider according to claim 18, wherein said dynamic data is updated periodically and further including the step of periodically updating said data provided to said third-party e-mail marketing service provider.

20. A method for providing data to a third-party e-mail marketing service provider according to claim 19, further comprising the step of applying a filter to said member database prior to said step of selecting a subset.
